(19) United States
(12) Patent Application Publication
(10) Pub. No.: US 2002/0038368 A1
(43) Pub. Date: Mar. 28, 2002

(54) User interface integration method

(76) Inventors: Gou Kojima, Tokyo (JP); Tetsuo Tanaka, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/967,010

(22) Filed: Sep. 27, 2001

(30) Foreign Application Priority Data
Sep. 28, 2000 (JP) 2000-300564

(51) Int. Cl. G06F 15/173; G06F 15/16

(52) U.S. Cl. 709/225; 709/250

(57) ABSTRACT

A user interface integration apparatus, upon reception of an integrated page creation request from a WWW browser, executes a user interface integration program, fetches pages constituting an integrated page from corresponding WWW application servers according to integrated page configuration information, creates an integrated page integrating the fetched pages, assign a copy function between common data, transmits the integrated page created on the WWW browser, and displays integrated page on the WWW browser.

### BACKGROUND OF THE INVENTION

The present invention relates to a method for integrating user interface and in particular, to an integration/linkage method which can preferably be used when providing an application from a server to a client via a network, so that the client can utilize a plurality of applications.

In a network such as Internet, application service is provided by utilizing WWW (World Wide Web) as user interface. By utilizing the WWW, there is no need of preparing a client program for each of the applications. With the WWW browser, it is possible to utilize all the applications using the WWW. However, applications using the WWW have a problem that even when processing data common to applications, there is no mechanism to link data between applications. In order to share data between applications, a user should open a different window of WWW browser for each of the applications and perform data input operation.

To cope with this problem, JP-A-10-232899 discloses a system having a dedicated service linkage apparatus. In this system, by using an existing WWW service as basic service and defining an integrated form of a plurality of basic services, virtual service associated with linkage of the basic services is defined in advance. When providing a service, according to the definition, firstly, a virtual service object is created in an internal format utilizing a basic service object when necessary. Subsequently, the virtual service object created is executed to provide the virtual service in an operation format based on a single basic service.

Thus, by providing a service linkage apparatus, a user can integrate a plurality of basic services and provide them as if they were a single service. However, since in this system data passing between a plurality of services is performed in a service linkage apparatus, an end user utilizing the integrated service cannot know which data item of a service corresponds to a data item of another data item. Moreover, since processing for data passing is concentrated in the service linkage apparatus, a large load is applied to the apparatus.

### SUMMARY OF THE INVENTION

It is therefore an object of the present invention to provide an integrated page of a multi-WWW service having a function to display a plurality of existing WWW service pages in a single window of the WWW browser and automatically copy data items shared between WWW service pages on the WWW browser.

In the user interface integration method according to the present invention, a plurality of existing WWW services handling common data items are displayed in a single browser window. A page displaying a plurality of WWW service pages in a single browser window will be referred to as an integrated page. The user interface integration apparatus executing the user interface integration method accesses a WWW server providing an existing WWW service defined as an object to be integrated, fetches respective pages, and creates an integrated page based on the fetched pages. Moreover, when definition of the integrated page contain data items common to a plurality of pages as an object, the user interface integration apparatus creates an integrated page by inserting a script for automatically copying the common data items on the browser, into the fetched page.

According to this method, it is possible to utilize a plurality of WWW service pages as a single integrated page. When a data item common to pages constituting the integrated pages is present, it is possible to automatically copy data input to a data field of one of the pages, to a data field for common data items of the other page. Thus, it is possible to provide an integrated page having visible data linkage for a user.

### BRIEF DESCRIPTION OF THE DRAWINGS

FIG. 1 is a block diagram showing a functional configuration of the present invention.

FIG. 2 is an integrated page configuration table showing an integrated page configuration.

FIG. 3 is a configuration page showing a page constituting an integrated page.

FIG. 4 is a copy data table showing common data items assigning a copy function in an integrated page.

FIG. 5 shows browser display of an order-reception confirmation service page as an object of an integrated page.

FIG. 6 is a diagram showing an HTML source codes of the order-reception confirmation service page as an object of an integrated page.

FIG. 7 shows browser display of an inventory confirmation service page as an object to be integrated to an integrated page.

FIG. 8 shows an HTML source codes of an inventory configuration service page to be integrated into an integrated page.

FIG. 9 shows a browser display of the integrated page.

FIG. 10 shows an HTML source codes of the integrated page.

FIG. 11 shows an example of JavaScript of copy script used for the copy function in the integrated page.

FIG. 12 shows a flow of a processing procedure of the present invention.

FIG. 13 shows a template script for creating an integrated page.

FIG. 14 is a data correspondence table for correspondence between a plurality of pages as objects to be integrated.

### DESCRIPTION OF THE EMBODIMENTS

Description will now be directed to embodiments of the present invention with reference to the attached drawings.

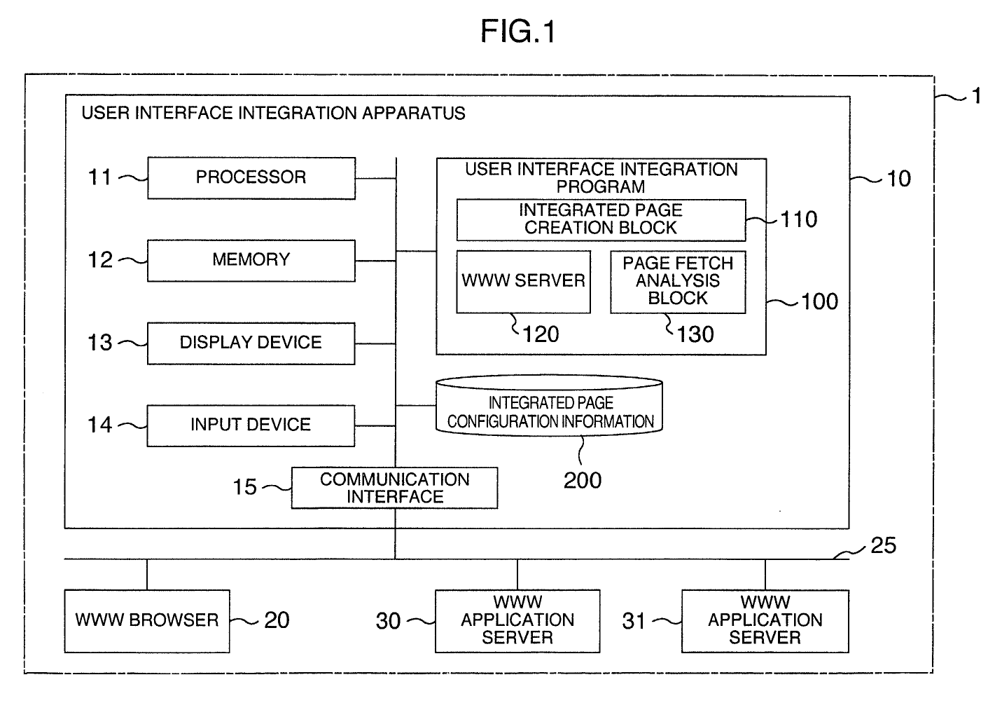

FIG. 1 is a functional block diagram showing a functional configuration according to the present invention through an example where a plurality of departments in an enterprise are connected by LAN (intranet) within the enterprise.

In FIG. 1, numeral 10 denotes a user interface integration apparatus. In the user interface integration apparatus 10, pages provided from a plurality of WWW services of a department according to a request from WWW browser of another department as a client are arranged as a single page-constituting part. The user interface integration apparatus 10 creates an integrated page having a copy function for copying common data items shared by a plurality of WWW services and transmits the integrated page created, to WWW browser of a request source.

Numerals 30 and 31 denote WWW application servers providing service of application having interface by WWW page used, for example, in a order-management department and s stock-management department.

Numeral 20 is a client WWW browser utilizing service by WWW. According to an embodiment of the present invention, the client WWW browser is a client utilizing an integrated WWW service transmitted from the user interface integration apparatus such as a WWW browser in goods-management department. The user interface integration apparatus 10, the WWW browser 20, and the WWW servers 30 and 31 are connected to one another by LAN 25 within an enterprise 1.

The user interface integration apparatus 10 includes a processor 11, a memory 12, a display device 13, an input device 14, and a network communication interface 15. The memory 12 has OS for operating as a user interface integration apparatus, communication software, and various programs stored. The user interface integration apparatus 10 has a user interface integration program 100 which will be detailed later, as software characteristic to the present invention, and further integrated page configuration information 200 describing integrated page configuration information to be referenced by the user interface integration program 100.

The user interface integration program 100 includes: an integrated page creation block 100 for creating an integrated page by referencing integrated page configuration information 200; a WWW server 120 for creating an integrated page according to a request from the WWW browser and returning the integrated page to the WWW browser 20 as the request source; and a page fetch analysis block 130 for accessing to the WWW application servers 30 and 31 upon creation of an integrated page to fetch and analyze pages provided by the WWW application servers 30 and 31.

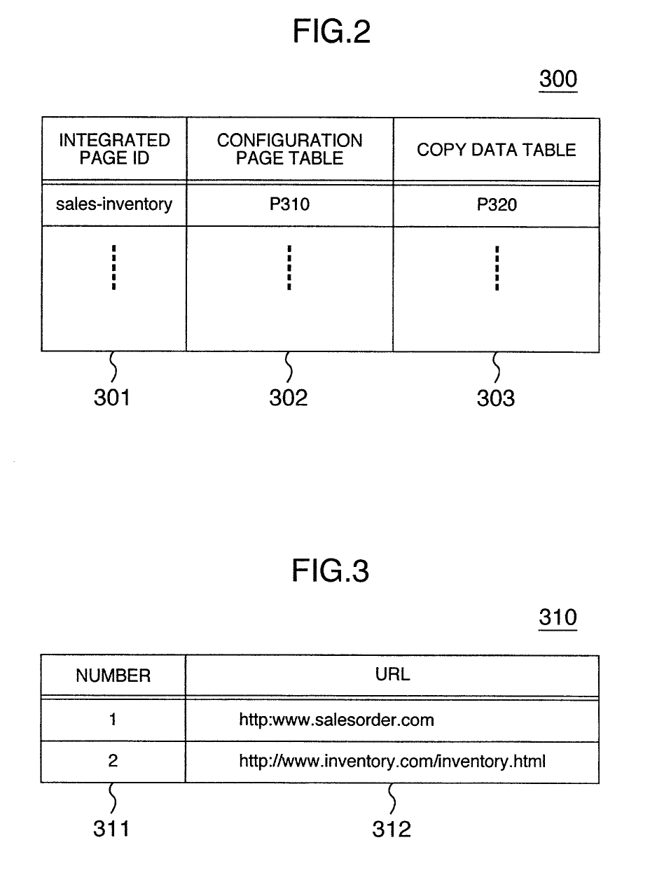

The integrated page configuration information 200 has an integrated page configuration table 300 shown in FIG. 2.

The integrated page configuration table 300 has an integrated page ID 301, a configuration page table pointer 302, and a copy data table pointer 303. The configuration page table pointer 302 indicates a position containing the configuration page table 310 indicating a page of the WWW services integrated to the integrated page. The copy data table pointer 303 indicates a position containing a copy data table indicated common data to be copied between pages shown in the configuration page table 310.

FIG. 3 shows an example of the configuration page table 310 of the integrated page specified by the integrated page ID named “sales-inventory” which is linked to the configuration page table pointer 302. The configuration page table 310 includes a number 311 indicating a number of the configuration page and an URL 312 indicating the URL of the configuration page. In the example of the configuration page table of FIG. 3, the integrated page indicated by the integrated page ID named “sales-inventory” is constituted by two WWW pages. One of the pages can be accessed by URL of http://www.salesorder.com. The other of the pages can be accessed by URL of http://www.inventory.html.

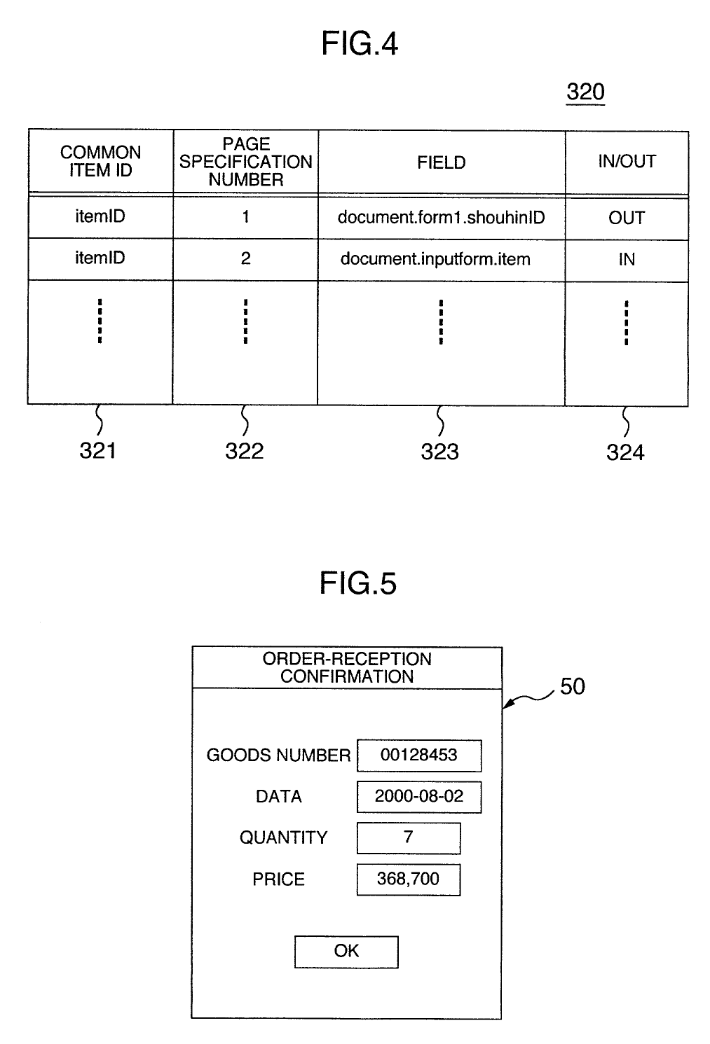

FIG. 4 shows an example of the copy data table 320 showing correspondence of the common data to which copy function is to be added between configuration pages linked by the copy data table pointer 303 in the integrated page of the integrated page ID “sales-inventory” of the integrated page configuration table 300. In FIG. 4, the copy data table 320 includes, a common item ID 321, a page specification number 322 specifying a page by a value of the number 311 of the configuration page table 310, a field 323 indicating the field having copy data, and IN/OUT indicating a copy source (OUT), a copy destination (IN), or both of them (IN/OUT) upon data copying. In the example of the copy data table 320, the common item ID is used as “item ID” indicating relationship between copy data between pages in which the copy source is a field indicated by document.forml.shouhinID in a page of the page specification number 1 and the copy destination is a field indicated by document.inputform.item in a page of the page specification number 2. It should be noted that the IN/OUT function operates in such a manner that upon modification of data of another copy source (OUT), the local data is rewritten as a copy destination (IN) into that data and further when the local data is modified, copying is performed to a different copy destination. In case three or more data are defined in the common item ID, upon modification of at least one of the OUT data items, the other IN item becomes an object to be copied and is modified. The copy object may be all of the items of the other IN.

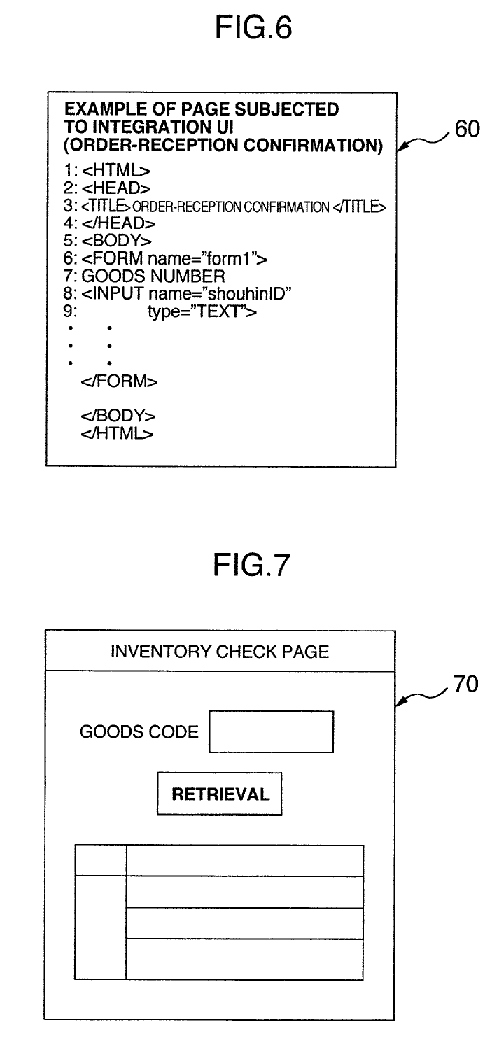

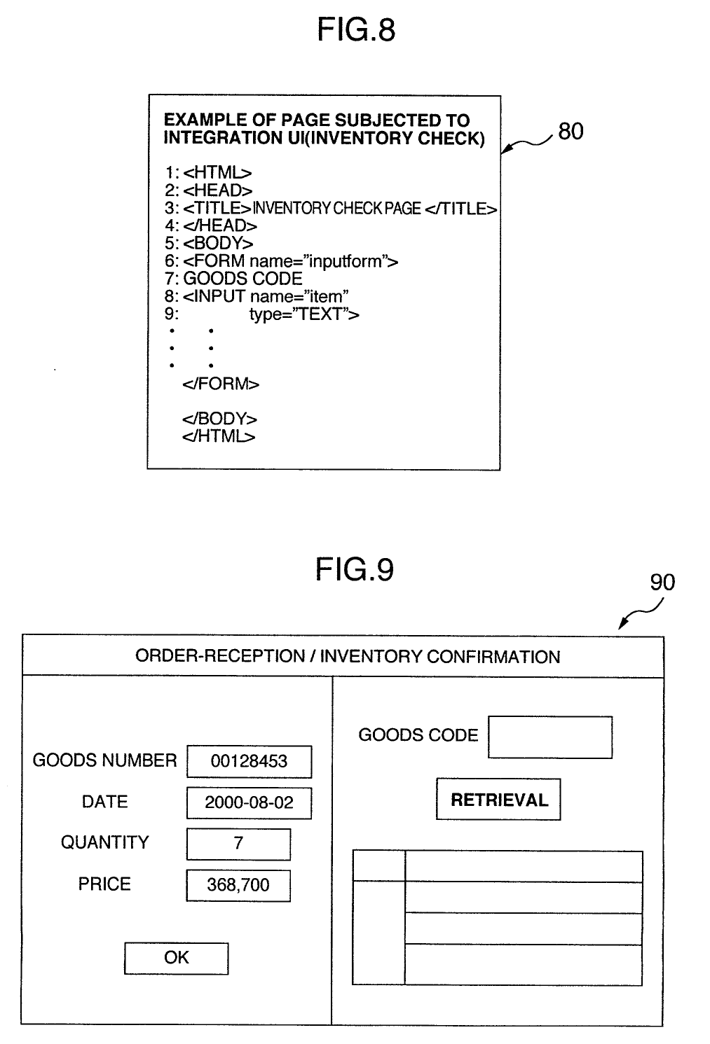

FIG. 5 shows a page 50 of the order-reception configuration service provided by the WWW application server 30 in the order-reception management department. FIG. 6 is HTML source codes 60 of the page 50. In FIG. 6, line numbers are shown the left end of each line. The order-reception confirmation service is a service within the enterprise 1 which can be used by a staff in charge of the goods management department in the enterprise 1 so as to check information of goods order received by a customer. Moreover, FIG. 7 shows a page 70 of an inventory confirmation service provided by the WWW application server 31 in the inventory management department. FIG. 8 is HTML source codes 80 of the page 70. In FIG. 8, line numbers are present at the left end of each line for explanation. The inventory confirmation service is also a service within the enterprise 1. This service enables a staff in charge of the goods management department to check inventory information of goods handed in the enterprise 1.

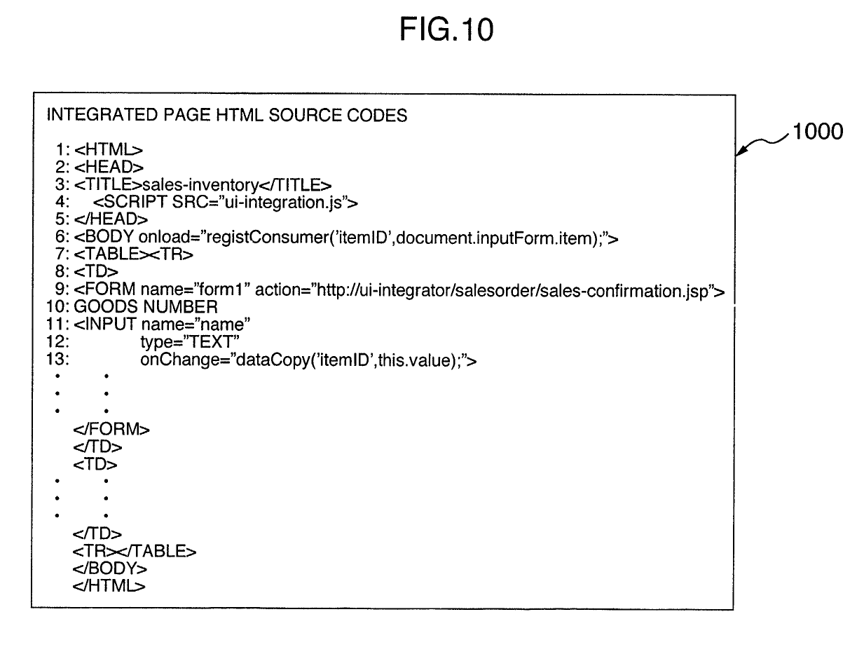

FIG. 9 shows an integrated page 90 integrating a page of order-reception confirmation service provided by the WWW application server 30 and a page of inventory confirmation service provided by the WWW application server 31 which are created by the user interface integration apparatus 10. FIG. 10 is an HTML source codes 1000 of the integrated page 90. In FIG. 10, a line number is given at the left end of each line for explanation. The integrated page integrating the page of order-reception confirmation service and the page of inventory confirmation service is used by a staff in charge of the goods management department for checking information on goods order by a customer to decide whether the goods indicated in the ordered goods information is present in stock for performing reservation.

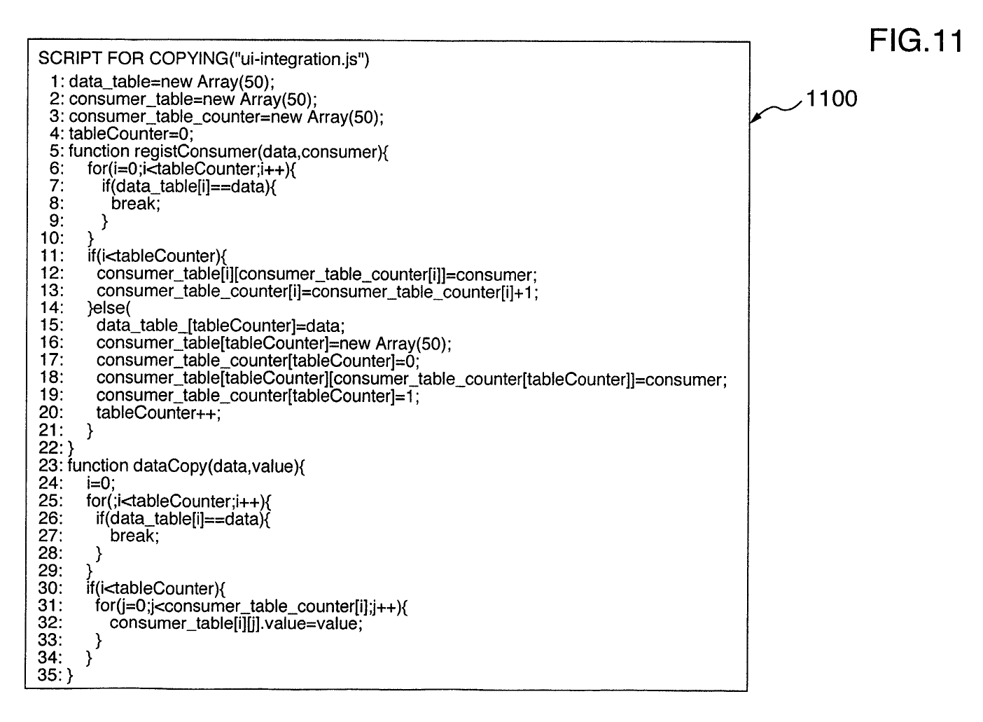

FIG. 11 is an example of JavaScript of the script 1100 for copy which is required for realizing the copy function in the integrated page. The Java Script is precisely described in “JavaScript1. 1.1, Introduction to Programming” issued by Prentice Hall (written by Laura Lemay/Michael Moncur, translated by Netizumu Koubou (Nettism Factory)). The script 1100 for copy in FIG. 11 assumes a buffer area for referencing a data copy source and a copy destination through a common data item name upon data copying. As for the copy destination, by calling a function “regist Consumer” defined on the fifth line and after in the copy script 1100, the self-field is loaded together with the common data item name. As for the copy source, by calling a function “data Copy” defined on the 23-rd line and after in the copy script 1100, data is written in the buffer domain using a common data item name and the data is copied from the buffer domain to the copy destination field loaded. By inserting this copy script 1100 into the integrated page 90 and by inserting a code to utilize the copy script 1100 into a field to be copied in the integrated page 90, the integrated page 90 can have the copy function.

In this embodiment, the user interface integration apparatus 10 displays as a single integrated page shown in FIG. 9 the respective pages utilized in the order-reception confirmation service and the inventory confirmation service which are the existing WWW services provided by the WWW application servers 30 and 31. Furthermore, the user interface integration apparatus 10 provides an order-reception confirmation—inventory confirmation integrated page having a function to copy data on the goods number as a data item output to the order-reception confirmation service, to a goods code as an input data item of the inventory confirmation service page.

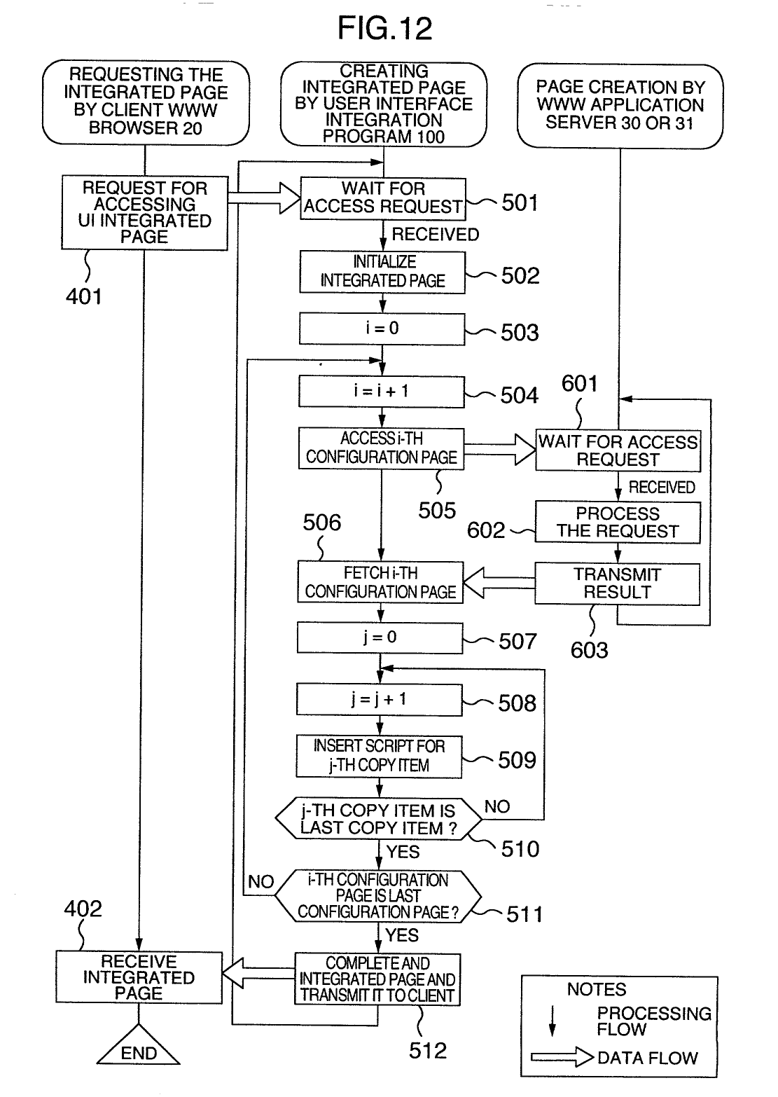

FIG. 12 shows a processing flow when the WWW browser 20 accesses the user interface integration apparatus 10 for utilizing the integrated page. The WWW browser 20 transmits an integrated page creation request to the WWW server 120 of the user interface integration program 100 according to specification by the staff in charge of the goods management department such as URL specification and click of a link in the displayed page (step 401). More specifically, the integrated page creation request includes URL of the WWW server 120 in the integrated page creation program 100 and an integrated page ID showing configuration of a desired integrated page.

The WWW server 120, upon reception of a request from the WWW browser 20 (step 501), analyzes the request from the WWW browser 20 and if the request contain an integrated page ID, an integrated page creation program 100 firstly initializes an integrated page to be created (step 502). More specifically, the initialization of the integrated page is performed by outputting line 1 to 6 of the HTML source codes of the integrated page in FIG. 10, i.e., the header of the HTML and <TABLE>tag and <TR>tag for defining a page are output. Next, attention is paid on a record in the integrated page configuration table having an integrated page ID specified by the request from the WWW browser 20. For the configuration page table linked to the configuration page table pointer of that record of interest, if the integrated page ID is “sales-inventory”, after initialization of the parameter i by the integrated page program 100, output of the configuration page in the integrated page is performed as follows.

Firstly, the parameter i is incremented (step 504) and a <TD>tag for isolating a page is output to the integrated page.

Next, URL indicated in the i-th record of the configuration page table 310 is read in and the ULR is made to access a page fetch analysis block 130 (step 505).

The WWW application server 30 or 31 accessed (step 601) executes processing of the access request (step 602) and transmits the result to the request source (step 603).

The page fetch analysis block 130 which has fetched the page of the result (step 506) firstly outputs the <TD>tag for isolating a page, to the integrated page and then outputs the fetched page as a page constituting the integrated page, to the integrated page. Next, attention is paid to a record having a page specification number i in the copy data table 320 linked to the copy data table pointer of the record of interest in the integrated page configuration table and a parameter j is initialized (step 507), after which script is inserted to the integrated page as follows.

Firstly, the parameter j is incremented (stepd 508). When IN/OUT of the j-th record among the records contained in the copy data table of interest 320 is “OUT”, script “onChange=“dataCopy” (‘<common item ID>’, this.value) is inserted as a field attribute of the item into the tag of the field indicated in the field 323 of the j-th record. In the case of the first record of the copy data table 320, the inserted script is “onChange=“dataCopy(‘itemID’,this.value);”as in line 13 of the HTML source codes 1000 of the integrated page of FIG. 10.

When the IN/OUT 324 of the record is IN, “on load=” registconsumer (‘<common item ID>’, <field>) is inserted as an attribute in the <BODY>tag of HTML which has been output as an initialization part of the integrated page. In the case of the second record in the copy data table 320, the inserted script is “onload=” registConsumer (‘itemID’,document.inputForm.item);” as in line 6 of the HTML source codes 1000 of the integrated page (step 509).

The script insert to the integrated page for copy data in each configuration page is repeated for all the copy data in the i-th configuration page and upon completion (step 510), the </TD>tag for page isolation is output to the integrated page.

Output of each configuration page in the integrated page is repeated for all the configuration pages and upon completion (step 511), the </TR>indicating the end of the end of the integrated page, a </TABLE>tag, a </BODY>tag, and </HTML>tag are output to complete the integrated page, and the completed integrated page is transmitted to the WWW browser 20 of the request source which has requested creation of the integrated page (step 512).

The WWW browser 20 which has received the integrated page outputs the received integrated page on the screen.

According to this embodiment, without directly handling the existing WWW application server, it is possible to integrate a plurality of existing WWW services and further to provide an integrated page having the function of common data copy between the WWW services on the WWW browser.

In the first embodiment, the user interface integration program 100 creates an integrated page according to the integrated page constituting information 200 but the user interface integration program 100 can also create an integrated page by using a script language describing a method for the integrated page creation. This script describing the integrated page creation method will be called hereinafter a template script. Explanation will now given on creation of an integrated page by using the template script according to a second embodiment of the present invention.

When creating an integrated page by using the template script, the user interface integration apparatus is configured that the integrated page constituting information 200 is modified to a template script and the integrated page creation block 110 is modified to a template script analysis/execution block. The template script is created by a skilled engineer in an enterprise or a developer of the user interface integration program 100 out of the enterprise and stored in the WWW server 120.

Moreover, the integrated page creation is realized as follows. That is access to the WWW server 30 or 31 by the integrated page constituting information and script insert for copy data indicated by steps 502 to 512 in processes shown in FIG. 12 are realized as execution of the template script by the template script analysis/execution block (110). Moreover, the integrated page creation request from the WWW browser 20 is made to be URL of the template script to create a desired integrated page. Hereinafter, explanation will be given on the template script execution by the template script analysis/execution block 110.

The WWW server 120 receives an integrated page creation request indicating URL of the template script from the WWW browser 20 and passes the request to the template script analysis/execution block 110.

The template script analysis/execution block 110 reads in the template script indicated in the request and executes a predetermined process described in the template script.

The codes and processing described in the template script will be detailed later. The template script analysis/execution block 110 fetches pages constituting the integrated page from the WWW application servers 30 and 31 which provide a plurality of pages constituting the integrated page which is the creation object of the template script, and creates an integrated page in which the plurality of pages fetches are arranged as a single page. Moreover, when a common data item is present between the plurality of pages constituting the integrated page, the integrated page inserts, on the WWW browser 20, a script for automatic copying between the common data items into the integrated page.

The template script analysis/execution block 110 passes the created integrated page to the WWW server 120. Upon reception of the integrated page, the WWW server 120 transmits the integrated page to the WWW browser 20 which is the integrated page request source.

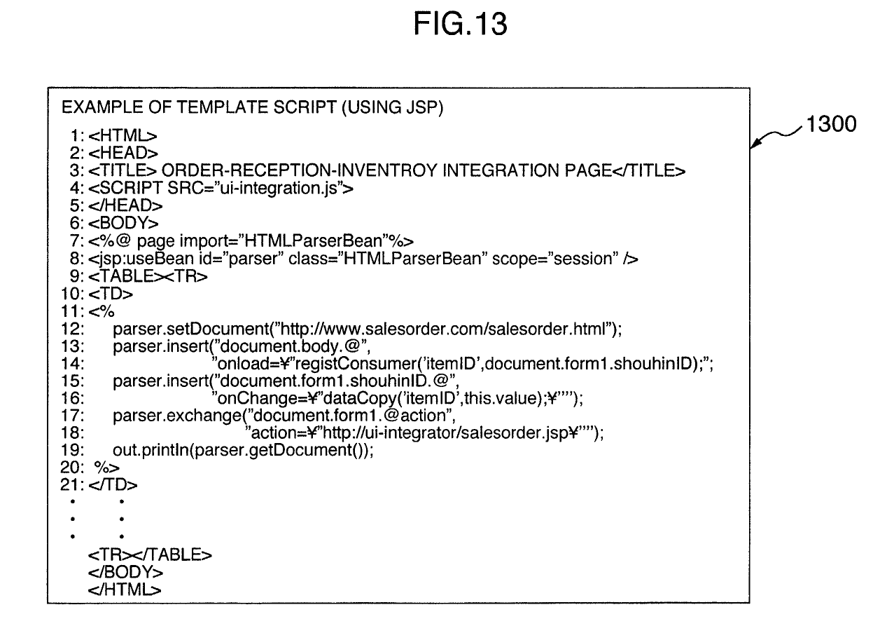

Hereinafter, explanation will be given on the codes described in the template script and its execution according to a description example of a template script 1300. The description example of the template script in FIG. 13 is a description by JSP (Java Server Pages) which is a script for page creation in the WWW server of Java. The JSP is detailed, for example, in “JavaServer Pages™ Technology” (http://java.sun.com/products/jsp/) of the WWW page.

When the JSP is used as a template script, the template script analysis/execution block 110 has the JSP engine function for analyzing and executing the JSP.

Lines 7 and 8 of the description example of the template script 1300 of FIG. 13 describes use of the HTMLParserBean which is an analysis/processing component of the HTML page provided by the WWW service. The HTMLParserBean plays a role of the page fetch/analysis block 130. Line 12 describes fetching of a page of the order-reception confirmation service provided by the WWW application server 30 (HTML source codes of FIG. 5 and FIG. 6) as a constituting part of the integrated page. By this description, the template script analysis/execution block 110 makes HTMLParserBean access the WWW application server and fetch the page. Next, lines 13 to 16 describes insert of the script to a position specified by the fetched page. More specifically, lines 13 and 14 describe insert of onload=“registConsumer(‘itemID’, document.form1.name)” into the <BODY>tag on line 5 of the HTML source codes of FIG. 6 which is a page of the order-reception confirmation service. This insert script indicates that a text field indicated in line 8 of the HTML source codes of FIG. 6 is loaded as a data item of ID for the common item “item ID”, as a data destination. Moreover, lines 15 and 16 of the description example of the template script indicate that onchange=“dataCopy(‘itemID’, this.value);” into the <INPUT>tag on line 8 of the HTML source codes of FIG. 6. This insert script describes that the text field indicated line 8 of the HTML source codes of FIG. 6 as a data item of the common item ID “itemID” is used as a data copy source and when its value is set or modified, the value is copied to a field loaded in the data copy destination as a data item having the common item ID “itemID”.

Moreover, lines 17 and 18 of the description example of the template script 1300 describes that “action=http://www.salesorder.com/salesorder.cgi” in the <FORM>tag on line 6 of the HTML source codes of FIG. 6 is replaed by “action=http://ui-integrator/salesorder.jsp”.

This replacement of the FORM call destination is performed as follows. To insert a copy script as a constituting part of the integrated page, a template script (referenced by http://ui-integrator/salesorder.jsp) for the page fetched by the call is prepared, and the page fetched by the existing page and its template script is replaced so as to specify a FORM call destination. That is, link in the existing page constituting a part of the integrated page and page fetch by the FORM call are performed via the user interface integrating apparatus, thereby causing to insert a copy script as a constituting part of the integrated page for a new page to be fetched as well.

As compared to the first embodiment, this embodiment enables to obtain a more flexible integrated page.

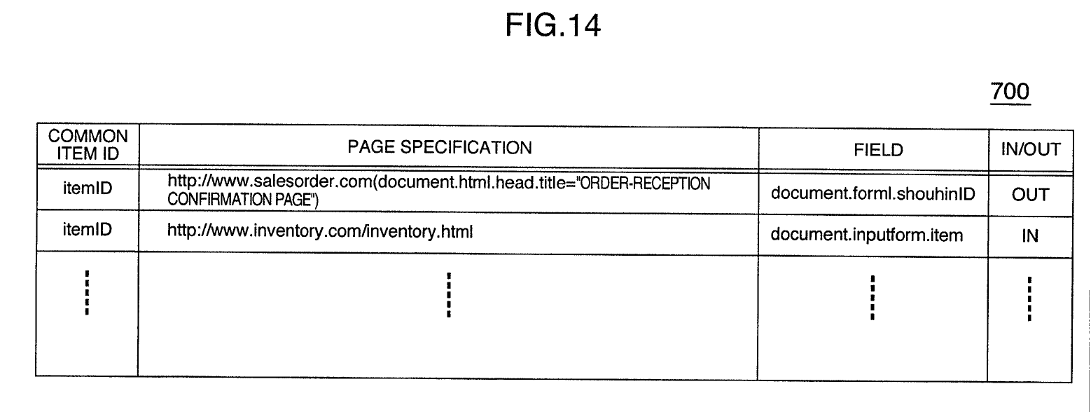

In the second embodiment, the template script is described by a creator of the integrated page in advance so as to be prepared in the user interface integrating apparatus. It is also possible to create a data correspondence table 700 between a plurality of WWW pages as shown in FIG. 14 by using a template script creation program as will be explained below. With this, by specifying a page as a constituting part of the integrated page according to a data correspondence map between the WWW pages, it is possible to automatically create a template script for creating the integrated page.

The template script creation program inputs specification of one or more existing WWW pages as constituting part of the integrated page and the data correspondence table 700 and outputs a template script for creating the integrated page.

The common item ID of the data correspondence table 700 indicates that data items having an identical ID are common data. Page specification specifies a WWW page containing the data and includes URL specifying a page and a condition sentence specifying the page. Normally, the WWW page specification is performed only by URL. However, when the page fetched by URL can be fetched by executing a CGI program, page configuration may dynamically be changed according to an input value. Accordingly, it is impossible to specify a page by the URL alone. For this, such as page specification on line 1 of the correspondence table shown in the data correspondence table 700, in addition to the URL, a value of a particular element in the page is added as a page specification condition for performing page specification. The field indicates a field of data in the page specified by the page specification. IN/OUT indicates a copy source (OUT), a copy destination (IN), or both (IN/OUT) upon data copying.

The template script creation program firstly creates a start portion of the template script. The start portion of the template script is a part from line 1 to line 8 in the template script example of FIG. 13. and includes a <HTML>tag and <HEAD>tag indicating start of the template script (HTML), a <TITLE>tag indicating a title, a <SCRIPT>tag indicating read-in of the script for copying (copy script), a <%@ tag indicating initialization of the HTML analysis component, a <TABLE>tag for isolating a page display, and <TR>. Specification of a plurality of existing pages constituting the integrated page for the template script to be created and entered by the user is read in, and the following operation is performed for each of the page specification. To utilize the specified existing page as a constituting part of the integrated page, in the same way as lines 10 to 12 of the template script example of FIG. 13, the template script creation program outputs the <TD>tag for page isolation, the <% tag indicating script description, and a code parser.setDocument (“<URL of the specified page>”); for causing the HTML analysis component to read the page.

Next, items having the specified existing page in the page specification of the data correspondence table 700 are detected. From the detected items, items having identical common item ID are extracted. When the IN/OUT item of the extracted item is IN, in the same way as lines 13 and 14 of the template script example of FIG. 13, a script for inserting onload=“restConsumer (<common item ID>,<field>” into the BODY tag is output. When IN/OUT of the extracted item is OUT, in the same way as lines 15 and 16 of the template script example of FIG. 13, a script for inserting onChange=“dataCopy (<common item ID>,this.value” as the attribute of the item field into the BODY tag. When the IN/OUT item of the extracted item is IN/OUT, the both of the aforementioned operations for IN and OUT are performed. Upon completion of output of insert script for copying for all of the extracted items, a code out.printIn(parser.getDocument( ); for outputting the page as the result of insert of the copy script constituting the integrated page is output, and %>indicating the script end and </TD>tag for page isolation are output.

After performing the aforementioned processing for all of the specified existing pages, an end portion of the template script is created. The end portion of the template script corresponds to the last three lines of the template script example of FIG. 13 and includes the </TR>tag for page isolation, the </TABLE>tag, and a </BODY></HTML>tag indicating the end of the template script (HTML).

By using the aforementioned template script creation program for creation of a template script, it is possible to easily create a template script only by preparing the data correspondence table 700 as shown in FIG. 14. Further, it is possible to easily provide an integrated page.

A program for executing the aforementioned user interface integration method according to the present invention can be stored in a storage medium readable by a computer and this program can be executed by reading the program into memory.

Moreover, in the aforementioned embodiment, the present invention is applied to configuration using LAN within an enterprise. However, the present invention can also be applied to configuration in which the user interface integration apparatus 10, the WWW browser 20 as a client, and the WWW application servers 30 and 31 are connected to one another via Internet 25. In this case, in response to a request from the client WWW browser 20, the user interface integration apparatus 10 creates an integrated page integrating two pages of the WWW application servers 30 and 31 and transmits the integrated page to the client WWW browser 20.

1. A user interface integration method executed by a processing apparatus connected to a client and a plurality of servers via a communication network, the method comprising steps of:
preparing user interface information including: server definition information defining the plurality of servers providing user interfaces constituting an integrated user interface provided to the client; and copy data information for assigning a function for copying common data between user interfaces constituting the integrated user interface;
upon a request from the client, requesting for the user interface to each of the servers providing the user interfaces constituting the integrated interface, according to the integrated user interface information;
assigning the copy function to each of the user interfaces transferred from the respective servers, according to the integrated user interface information, thereby creating an integrated user interface integrating the user interfaces having the copy function; and
transmitting the integrated user interface to the client so as to display the integrated user interface to the client.

2. A user interface integration apparatus connected to a client and a plurality of servers via a communication network, the apparatus comprising:
means for preparing user interface information including: server definition information defining the plurality of servers providing user interfaces constituting an integrated user interface provided to the client; and copy data information for assigning a function for copying common data between user interfaces constituting the integrated user interface;
means for, upon a request from the client, requesting for the user interface to each of the servers providing the user interfaces constituting the integrated interface, according to the integrated user interface information;
means for assigning the copy function to each of the user interfaces transferred from the respective servers, according to the integrated user interface information, thereby creating an integrated user interface integrating the user interfaces having the copy function; and
means for transmitting the integrated user interface to the client so as to display the integrated user interface to the client.

3. A computer program product storable on a computer readable storage medium, said program product containing a program for executing a user interface integration method performed by a processing apparatus connected to a client and a plurality of servers via a communication network, the method comprising steps of:
preparing user interface information including: server definition information defining the plurality of servers providing user interfaces constituting an integrated user interface provided to the client; and copy data information for assigning a function for copying common data between user interfaces constituting the integrated user interface;
upon a request from the client, requesting for the user interface to each of the servers providing the user interfaces constituting the integrated interface, according to the integrated user interface information;
assigning the copy function to each of the user interfaces transferred from the respective servers, according to the integrated user interface information, thereby creating an integrated user interface integrating the user interfaces having the copy function; and
transmitting the integrated user interface to the client so as to display the integrated user interface to the client.

4. An integrated page creation method executed by a processing apparatus connected to a WWW browser and a plurality of application servers via a communication network, the method comprising steps of:
preparing an integrated page creation script describing a procedure for creating an integrated page integrating a plurality of pages provided by the plurality of servers, into a single page;
upon request from the browser, requesting, according to the integrated page script, each of the servers providing pages constituting the integrated page, to provide the aforementioned page;
assigning a copy function to each of the pages transferred from the respective servers, according to information of the integrated page, and creating an integrated page which integrates the pages having copy function into a single page; and
transmitting the integrated page to the browser so as to display the integrated page on the browser.

5. The user interface integrating method as claimed in claim 1, wherein the client is a WWW browser; the plurality of servers are WWW application servers; user interfaces provided by the respective servers are pages provided by the WWW application servers; and the integrated user interface is an integrated page which integrates the aforementioned pages.

6. The user interface integration method as claimed in claim 5, wherein the processing apparatus, the WWW browser, and the servers are connected to one another via LAN (local area network) in an enterprise.

7. The user interface integration method as claimed in claim 1, wherein the copy data information includes an “OUT” type indicating a common data of a user interface as a copy source and an “IN” type indicating a common data of a user interface as a copy destination.

8. The user interface integration method as claimed in claim 7, wherein the copy data information further includes an “IN/OUT” type indicating a common data of one user interface as a copy destination and, with respect to another user interface, the common data of said another user interface as a copy source when the common data is modified at said one user interface.

9. The user interface integration apparatus as claimed in claim 2, wherein the copy data information includes an “OUT” type indicating a common data of a user interface as a copy source and an “IN” type indicating a common data of a user interface as a copy destination.

10. The user interface integration apparatus as claimed in claim 9, wherein the copy data information further includes an “IN/OUT” type indicating a common data of one user interface as a copy destination and, with respect to another user interface, the common data of said another user interface as a copy source when the common data is modified at said one user interface.

11. A computer program product for an integrated page creation method executed by a processing apparatus connected to a WWW browser and a plurality of application servers via a communication network, the method comprising steps of:
preparing an integrated page creation script describing a procedure for creating an integrated page integrating a plurality of pages provided by the plurality of servers, into a single page;
upon request from the browser, requesting, according to the integrated page script, each of the servers providing pages constituting the integrated page, to provide the aforementioned page;
assigning a copy function to each of the pages transferred from the respective servers, according to information of the integrated page, and creating an integrated page which integrates the pages having copy function into a single page; and
transmitting the integrated page to the browser so as to display the integrated page on the browser.
